(19) United States
(12) Patent Application Publication
(10) Pub. No.: US 2010/0168890 A1
(43) Pub. Date: Jul. 1, 2010

(54) Three-Dimensional Data Extraction Using Ray Casting

(75) Inventors: Judith L. Fisher, Pittsburgh, PA (US); Lawrence J. Voss, Pittsburgh, PA (US)

Correspondence Address: IP & INTERNET LAW NORTH, LLC, P.O. BOX 38, ZELIENOPLE, PA, 16063, US

(73) Assignee: EX ONE CORPORATION, Irwin, PA (US)

(21) Appl. No.: 11/886,668

(22) PCT Filed: Mar. 24, 2005
(86) PCT No.: PCT/US2005/010028

§ 371 Date: Dec. 11, 2007

(51) Int. Cl. G06F 17/50

(52) U.S. Cl. 700/98; 700/119; 700/120

(57) ABSTRACT

Methods are provided for solid free-form fabrication of an article without using a slice stack file. These apply ray casting a number of times to an electronic representation of the article to create data objects for use directly as printing instructions or which are convertible into printing instructions. The data objects may be utilized as they is generated or after they are created for a portion or all of the article. After utilization, the data objects may be discarded or stored for later use. Layer-specific layer thickness and other-direction resolution parameters may be input and utilized in selecting the number of rays to be cast, their origination points, and their directions, thus permitting controllable variation in detail precision in any direction. Error diffusion techniques may be used to improve fabricated part integrity. Improved intermachine portability is provided. Method, system, code, and media claims are included.

### FIELD OF THE INVENTION

The present invention relates to the field of solid free-form fabrication. In particular, the invention relates to methods for transforming a data file containing a three dimensional mathematical model of the physical article that is to be produced by solid free-form fabrication into instructions to the printing mechanism for the layer-by-layer construction of the physical article.

### BACKGROUND OF THE INVENTION

In recent years, solid free-form fabrication processes have been developed for producing a physical article directly from an electronic representation of the article. The term “solid free-form fabrication process” (“SFFF”) as used herein and in the appended claims refers to any process that results in a three-dimensional physical article and includes a step of sequentially forming the shape of the article one layer at a time from an electronic representation of the article. Solid free-form fabrication processes are also known in the art as “layered manufacturing processes.” They are also sometimes referred to in the art as “rapid prototyping processes” when the layer-by-layer building process is used to produce a small number of a particular article. A solid free-form fabrication process may include one or more post-shape forming operations that enhance the physical and/or mechanical properties of the article. Examples of solid free-form fabrication processes include the three-dimensional printing (“3DP”) process and the Selective Laser Sintering (“SLS”) process. An example of the 3DP process may be found in U.S. Pat. No. 6,036,777 to Sachs, issued Mar. 14, 2000. An example of the SLS process may be found in U.S. Pat. No. 5,076,869 to Bourell et al., issued Dec. 31, 1991. Solid free-form fabrication processes in accordance with the present invention can be used to produce articles comprised of metal, polymeric, ceramic, composite materials, and other materials. The development of solid free-form fabrication processes has produced a quantum jump reduction in the time and costs incurred in going from concept to manufactured article by eliminating costly and time-consuming intermediate steps that were traditionally necessary.

Many solid free-form fabrication processes consist of the basic steps of: (1) applying and smoothing out a first layer of a build material, e.g., a powder, to a vertically indexable build stage; (2) scanning the build material layer with the printing mechanism to impart to it the image of the relevant two-dimensional layer of the article being built; (3) lowering the stage to receive another layer of build material; and (4) repeating steps (1) through (3) until the article is completed. The layer-by-layer construction results in the formation of the desired physical article. Subsequent processing is often employed to enhance the physical properties of the constructed physical article.

The term “printing mechanism” as used herein and in the appended claims generically refers to the component of the solid free-form fabrication system that (1) physically imparts the image of the relevant two-dimensional layer of the article that is being constructed onto a construction material that is upon the stage upon which the article is being built, and/or (2) deposits a layer of a construction material in the image of such a two-dimensional layer upon the stage or a previous layer. For example, in the 3DP process, the printing mechanism is a print head comprising one or more print jets and associated scanning and control mechanisms that spray droplets of a binder fluid onto a powder layer to form the image of the relevant two-dimensional layer of the physical article. In the SLS process, the printing mechanism is a laser and associated scanning and control mechanisms that scan a laser beam across a powder layer to fuse powder therein together in the form of the image of the relevant two-dimensional layer of the physical article.

A physical article that is to be constructed by solid free-form fabrication is first represented electronically as a three-dimensional model. Typically, the three-dimensional model is stored in the format of a stereolithographic file. Files in this format are referred to herein and in the amended claims as “STL files.” An STL file typically comprises of a collection of triangles which sketch out the exterior and interior surfaces of the physical article. Features such as surface normals, i.e., a short ray pointing perpendicularly out from a face of the triangle, are associated with the triangles to indicate which surface of the triangle is facing outward from the physical object.

Conventionally in solid free-form fabrication, an STL file is operated upon by a program that is referred to herein and in the amended claims as a “slicing program.” A slicing program slices the model that is in STL file format along one of three mutually orthogonal axes, e.g., the Z-axis of a set of X-Y-Z axes, to create a stack of two-dimensional layers of a specified layer thickness, i.e., slices. Within each slice, the relevant portion of the model is represented by two-dimensional closed polygons.

The slicing program is typically a separate program, e.g., the Magics RP program which is available from the Materialise NV, Leuven, Belgium. However, a slicing program may also be a subset of a larger program that processes the STL file or functionally similar file into instructions for a solid free-form fabrication machine to construct the physical article. In either case, application of the slicing program results in a binary file which comprises a stack of two-dimensional slices wherein each two-dimensional layer is represented by two-dimensional closed polygons. Such binary files are referred to herein and in the amended claims as “slice stack files.”

Traditionally, the control software of the solid free-form fabrication machine utilizes a slice stack file to manufacture the physical article layer-by-layer. Typically, the solid free-form fabrication machine control software transforms each model layer represented in the slice stack file into a set of instructions for controlling the printing mechanism in the creation of the corresponding physical layer of the physical article. These instructions tell the printing mechanism where to cause the build material to be (1) bound together, e.g., through the application of energy from a lasing device or through the jetting of a binder from a jet print head, and/or (2) deposited. This operation of the printing mechanism is referred to generically herein and in the amended claims as “printing” and these instructions are referred to generically herein and in the amended claims as the “printing instructions,” irregardless of the type of printing mechanism that is actually employed.

FIG. 1 presents a flowchart representation of a conventional process for creating a physical article by solid free-form fabrication. In exemplar conventional process 10, STL file data 12 for a model of the physical article that is to be built is input into a slicing program 14. Also input into the slicing program 14 is the selected layer spacing value 16 that is to be applied to the entire model. The slicing program 14 uses this input to create a slice stack file 18. Each planar slice is separated from the next slice by the selected layer spacing value 16. Data from the slice stack file 18 is then input into a storage device 20. Subsequently, the data from the slice stack file 18 is output from the storage device 20 into the control software 22 of a solid free-form fabrication machine. The control software 22 processes the slice stack file 18 data to create printing instructions 24 for causing the printing mechanism 26 to print each layer 28 until the completion of the physical article 30.

There are several drawbacks to the conventional method. Among these are the costs occasioned by the need to utilize a slicing program. These costs include the cost of purchasing or developing, implementing, and/or maintaining the slicing program. They also include the costs of the hardware that must be allocated to the operation and the storage of the slicing program and the resulting slice stack files. They further include the computational costs of utilizing the slicing program and then utilizing the slice stack files. Additionally, there is the cost of the time needed to utilize the slicing program to create the slice stack files.

Another drawback is the loss of detail and other information from the original three-dimensional model of the physical article. Each time a data set representing the model is transformed, some detail and information about the model is lost. Slicing programs attempt to represent the models they are operating upon in terms of particular slice planes. Thus, all information from the original model about details that exist between the slice planes is not captured by the slicing program and is therefore lost. This means the original model is not available from the slice stack file for viewing, moving, scaling, or other operations. This also means that the slice stack file can only be used by a solid free-form fabrication machine that is capable of utilizing the particular slice thickness that was selected in creating the slice stack file and which is capable of using the same printing device indexing steps and other parameters. This limits the portability of the slice stack file from one solid free-form fabrication machine to another.

### DISCLOSURE OF INVENTION

The present invention overcomes at least some of the problems associated with the prior art by providing a method for making a physical article by solid free-form fabrication which does not require the use of a slice stack file. To accomplish this, preferred embodiments of the present invention apply ray casting a number of times to an electronic three-dimensional model of the physical article to create a set of data objects which can be used directly as printing instructions or which are readily convertible into printing instructions. In other words, these preferred embodiments of the present invention involve a step of performing ray casting into an electronic representation of the article to determine at least one location to be printed by the solid free-form fabrication machine for fabricating the article. The ray casting data may be so utilized as it is generated or after it is collected for a predetermined portion of the model. Preferably, the ray casting is done while the physical article is being built on the solid free-form fabrication machine. Also, preferably, the ray casting data is collected for a layer of the model that corresponds to the layer of the physical article that is about to be constructed by the solid free-form fabrication machine. After the ray casting data has been utilized, it may be discarded or it may be stored for later use.

In ray casting, a mathematical ray is drawn from a selected starting point in a selected direction for a selected distance through a selected volume of space which contains one or more objects. Information is collected about the intersections of the ray with any of the objects, such as the coordinates of the point of intersection and other useful information.

FIG. 2 illustrates and example of ray casting. The selected space volume 42 contains an object, in this case a two dimensional rectangle 44. A coordinate system 46 is applied to the space volume 42 in any desired manner. An origination point 48 and direction 50 are chosen for the ray 52. In this case, the ray casting distance selected is indicated by the length of the ray 52 which extends from its origination point 48 to the edge of the space volume 42. The ray 52 intersects rectangle 44 at point 54. The rectangle side 56 which faces the origination point 48 of ray 52 has a surface normal 58. The direction of surface normal 58 is indicated by its arrowhead and provides useful information about the orientation of rectangle 44 within space volume 42.

In preferred embodiments of the present invention, an X-Y-Z coordinate system of three mutually orthogonal axes is applied to the selected space volume. The space volume is preferably chosen to represent the spatial volume occupied by the print box of the solid free-form fabrication machine. The Z-axis is preferably oriented with its positive direction along the vertical build direction of the print box so that each print layer is represented by an X-Y plane. In such preferred embodiments, ray casting is first done on the base plane of the coordinate system, i.e., the X-Y plane for which the Z-value is zero. Rays are cast across the base plane until sufficient information is collected to determine where the printing mechanism needs to print for the layer that corresponds to the base plane to construct the first layer of the physical object. That information is used to create printing instructions for the solid free-form fabrication machine and may then be discarded. Discarding this information reduces the amount of memory resources that are needed for the process. The process is repeated for each subsequent build layer until the construction of the physical article has been completed. Layer-specific layer thickness and other-direction resolution parameters may be input and utilized in selecting the number of rays to be cast, their origination points, and their directions. For greater resolution, denser ray casting may be used, e.g., by using a greater number of rays, cast from closer spaced origination points. Greater resolution may also be achieved through increasing the number of directions in which rays are cast, with or without increasing the number of ray origination points.

Although it is preferred that ray casting be performed upon the model of the physical article on a layer-by-layer basis, the present invention is not so limited. For example, in some embodiments of the present invention ray casting is done from one or more preselected points of the relevant space volume. In those embodiments, the data from the ray casting are collected into an electronic file and then sorted to yield layer-specific locations. These locations may then be used for printing the article. The sorting may be done just-in-time for a given layer to be printed and the results discarded after use or stored for reuse. Alternatively, the sorting may be done and the results stored for later printing use.

In all embodiments in which data resulting from the ray casting process is stored, the storage may be either volatile or permanent storage medium, whichever is desired for the particular application for which the embodiment is being used.

It is to be understood that the present invention also includes embodiments having coordinate system arrangements other than that comprising three mutually orthogonal axes. For example, it includes embodiments which employ cylindrical coordinate systems and polar coordinate systems.

It is also to be understood that the present invention includes embodiments in which more than one physical article is constructed at a time. For example, multiple copies of the same article may be constructed and/or one or more different articles may be constructed contemporaneously.

An advantage of the present invention is that it permits a variation in the precision of detail of the physical article in any direction, e.g., in any of the X, Y, or Z directions. This is accomplished in some preferred embodiments by locally varying the number of rays cast. Where greater precision is required, a greater number of rays are cast. Where less precision is required, fewer rays are cast. With regard to the precision in the build direction, in some embodiments this is accomplished by varying the selected value of layer thickness. Where layer thickness is varied, corresponding instructions as to the layer thickness are also provided to the device of the solid free-form fabrication machine that controls the thickness of the build material. Thus, the present invention permits the layer thickness to be varied for each layer within the range available for the particular solid free-form fabrication machine that is being employed. For example, a relatively large layer thickness may be used for constructing a portions of a physical article that has little or no change in detail, e.g.; a cylindrical portion, and then relatively smaller layer thicknesses may be used for constructing portions of the physical article that have finer detail. Moreover, some embodiments of the present invention permit such variations to be input while the physical article is being constructed, so that if an operator decides during the construction that greater or lesser detail precision is needed, he or she can make the desired adjustments to subsequent layers.

Another advantage of many embodiments of the present invention is that no information about the model of the physical model is lost since the model is not altered and may be reused in its original form for subsequent building operations or at any time during a particular building operation.

Another advantage of the present invention is the portability it provides. Since the ray casting may be done while or immediately before a layer is constructed, the resulting printing mechanism instructions are usable by the solid free-form fabrication machine in which the process being is run. However, the present invention also permits the collection of the ray casting data and the subsequent use of that data on other solid free-form fabrication machines with which it is compatible.

Although in preferred embodiments of the present invention, the ray casting is performed upon an STL file model of the physical article, the present invention is not limited to use with STL files. The model may be in any file format. Thus, even the native format of the model may be used in some embodiments of the present invention. In native format, the model of the physical article is described in terms of one or more mathematical equations.

In some embodiments of the present invention, the integrity of the printed article is enhanced by applying an error diffusion technique to the printing instructions generated as a result of the ray casting process. The use of an error diffusion technique ameliorates the problems caused when one or more printing device of a multi-printing device printing mechanism fails to print, e.g., when one or more jets of a multi-jet 3DP printing mechanism become blocked. In some embodiments of the present invention, this is accomplished by first printing the layer with a first assignment of printing devices and then reprinting the layer using different assignment of printing devices.

It is to be understood that while some embodiments of the present invention comprise processes for solid free-form fabrication of articles, other embodiments comprise systems and solid free-form fabrication machines specifically adapted for carrying out such processes. Still other embodiments of the present invention comprise computer readable instructions for producing articles by solid free-form fabrication using a ray casting method. Still other embodiments of the present invention comprise storage media containing computer readable instructions for producing articles by solid free-form fabrication using a ray casting method.

### BRIEF DESCRIPTION OF DRAWINGS

The criticality of the features and merits of the present invention will be better understood by reference to the attached drawings. It is to be understood, however, that the drawings are designed for the purpose of illustration only and not as a definition of the limits of the present invention.

FIG. 1 is a flowchart of a prior art process for producing a physical object by solid free-form fabrication.

FIG. 2 is a perspective diagram illustrating the concept of ray casting.

FIGS. 3A-B are a key to the flowcharts symbols appearing in FIGS. 4-14.

FIG. 4 is a high level flow diagram of a process embodiment of the present invention.

FIG. 5 is an intermediate level flow diagram depicting the third step illustrated in FIG. 4.

FIGS. 6A-C illustrate ray casting according to some embodiments of the present invention.

FIG. 6A is a perspective view of a pyramidal article within a coordinate system illustrating a simple type intersection between a ray and the article.

FIG. 6C is a perspective view as in FIG. 6A, but illustrating a planar type intersection between a ray and the article.

FIG. 6C is a perspective view as in FIG. 6A, but illustrating a point type intersection between a ray and the article.

FIG. 7 is a flowchart depicting a data loading step of a process embodiment of the present invention.

FIG. 8 is a flowchart depicting in detail a first step of a process embodiment of the present invention.

FIG. 9 is a flowchart depicting in detail a second step of a process embodiment of the present invention.

FIG. 10 is a flowchart depicting in detail a third step of a process embodiment of the present invention.

FIGS. 11A-B illustrate in detail a fourth step of a process embodiment of the present invention.

FIG. 11A is a flowchart depicting the fourth step.

FIG. 11B is a flowchart containing an continuation of FIG. 11A.

FIG. 12 is a flowchart illustrating a preferred process embodiment of the present invention.

FIGS. 13A-D illustrate in detail two alternatives for a fifth step of a process embodiment of the present invention.

FIG. 13A is a flowchart of the first alternative.

FIG. 13B is a high level flow chart of the second alternative.

FIG. 13C is a flowchart of an example of a second alternative.

FIG. 13D is a continuation of the flowchart of FIG. 13C.

FIGS. 14A-B illustrate an example of the instruction set for a printing mechanism resulting from the process depicted in FIGS. 13C-D.

FIG. 14A is representation of an empty i, j array corresponding to the locations of a build layer.

FIG. 14B is a representation of the i, j array depicted in FIG. 14A containing printing instructions.

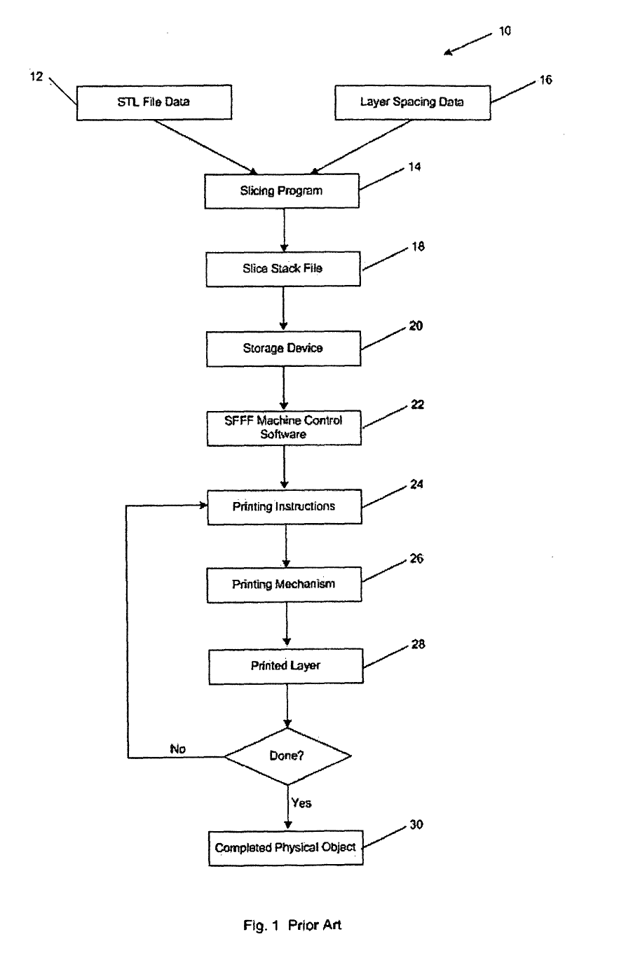

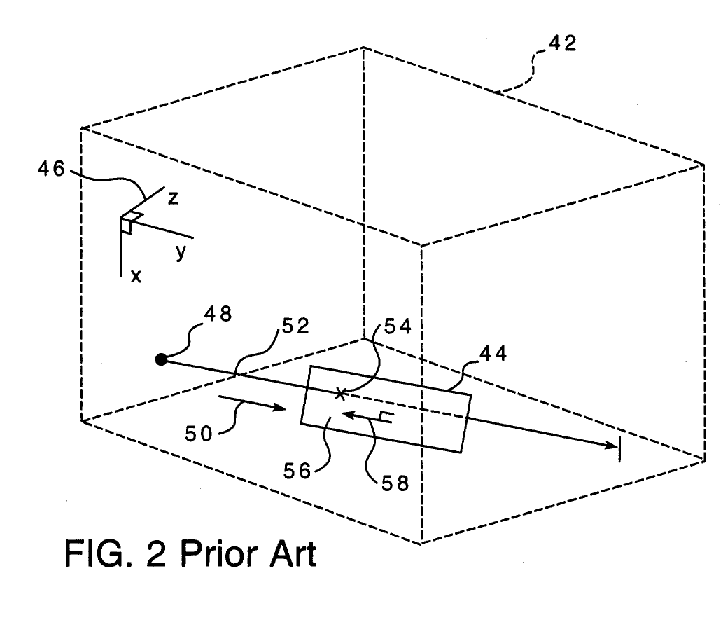

### MODES FOR CARRYING OUT THE INVENTION

In this section, some preferred embodiments of the present invention are described in detail sufficient for one skilled in the art to practice the present invention. It is to be understood, however, that the fact that a limited number of preferred embodiments are described herein does not limit the scope of the present invention as set forth in the appended claims to such embodiments.

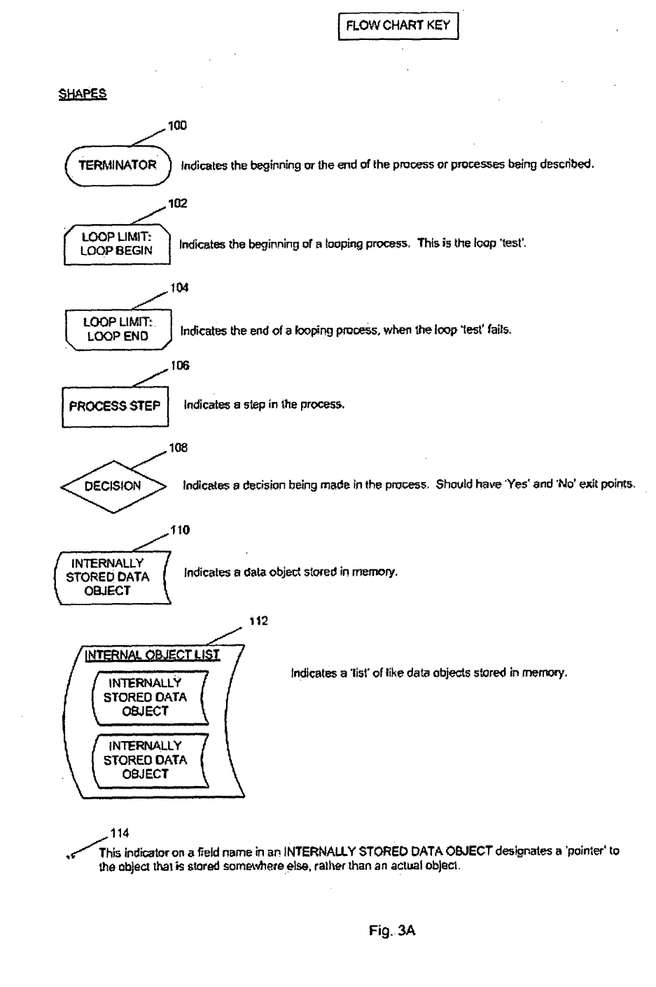

FIGS. 3A-B are presented to aid in the understanding the flow charts presented in this section. These figures present a key to the shapes and symbols used in those flow charts. In these figures, the text appearing within the shapes describes the function of the shape. The shapes and symbols are consistent with those identified in ISO standard 5807-1985. In the flow charts, this text is replaced with text that describes the particular functions or characteristics of the individual step or structure the shape is representing within a particular flow chart.

Referring to FIG. 3A, the first shape 100 represents a terminator, i.e., the beginning or end of a particular process or subprocess that is being described. The second shape 102 represents the beginning of a loop of process steps and thus marks the initial limit of an iteration of the loop. The third shape 104 is the companion of the second shape 102 as it marks the terminal end of the loop initiated by second shape 102. The fourth shape 106 represents a process step. This shape is also used as a title block for the flow chart, in which case it is free standing from the rest of the flow chart. The fifth shape 108 represents a decision point in the process. It usually has arrows extending from its side or bottom vertices which indicate the path direction to be taken based upon the result of the decision. These arrows are usually marked with the decision associated with the route, e.g., “yes” or “no.” The sixth shape 110 represents a data object stored in memory that is internal to the system in which the process is being conducted. The seventh shape 112 represents a list of data objects stored in internal memory. The double asterisks symbol 114 is used in conjunction with the field name of an internally stored data object to designate that what is actually being stored at that particular location where the asterisked name appears is a pointer, rather than the data object itself. A pointer is a guide to the location where the data object having the stated field name is actually stored.

Referring to FIG. 3B, the eighth shape 116 indicates a subroutine that is found on a separate page. The ninth and tenth shapes 117, 118 of the key indicate that continuations of the flow chart exists on another page. The ninth shape 117 is an “off-page reference” and indicates the flow chart continues from that point onto another page. The tenth shape 118 is an “on-page reference” and indicates that the flow chart is continued from another page at that point. The corresponding off-page/on-page references are identified by matching the reference letters that appear in their dashed-line boxes, e.g., reference letter 120.

FIG. 3B also shows three process flow indicators. The solid arrow 122 is a flow indicator which indicates the process flows in the direction pointed to by its arrowhead. The dashed arrow 124 pointing from a process step to an internally stored data object or internal list, e.g., from process step 126 to internally stored data object 128, indicates that information from the process is being placed into the internally stored data object or internal list. Conventionally, a dashed arrow 124 pointing from a process step to list has its arrowhead in contact with the last object on the list to indicate that the information is being added to the end of the list.

In contrast, the dashed arrow 130 pointing from an internally stored data object or internal list, e.g., from internally stored data object 132 to process step 134, indicates that information in the internally stored data object or list is being accessed by the process step, i.e., it is being supplied to the process step. Conventionally, a dashed arrow 130 pointing from a list to a process step points from the first item on the list to indicate that the entire list is consulted in providing the necessary data.

FIG. 3B also shows the horizontal and vertical three dashed-line symbols 136, 138. These symbols indicate continuation from one item to another. It is usually used between data items to indicate that the data items extend from a first element, e.g., Data1, to a higher number element, e.g. DataN.

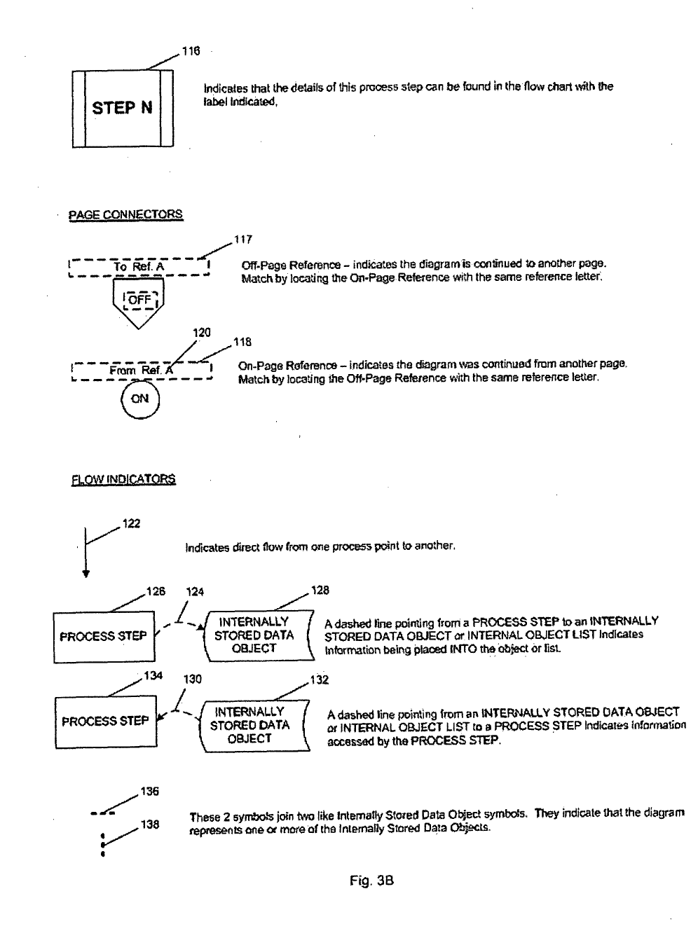

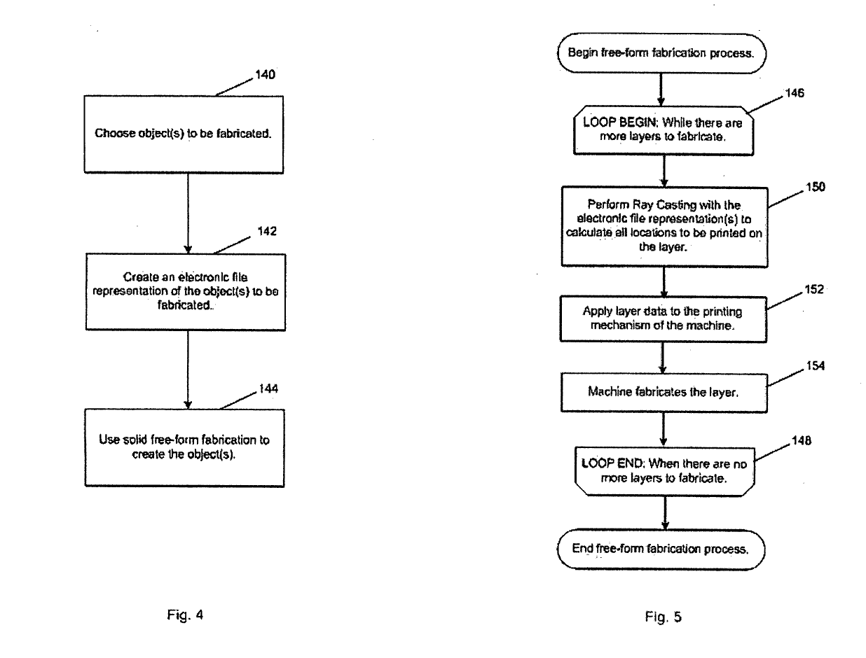

For conciseness and ease of description, each of the aforementioned first to tenth shapes will be simply referred to as a “block” in the descriptions of the flowcharts appearing in the various figures appended hereto. Some preferred method embodiments of the present invention will now be described with regard to FIGS. 4-14.

Referring to FIG. 4, there is shown there a high level flow diagram which depicts, in general terms, the steps of some preferred process embodiments of the present invention. Terminal blocks have been omitted from this diagram. The first step, block 140, is to choose the physical article or articles that are to be fabricated. The second step, block 142, is to create an electronic model of the chosen article or articles. The third step, block 144, is to use solid free-form fabrication to create the article or articles. The third step will now be described in more detail.

FIG. 5 is an intermediate level flow diagram showing in more detail the third step, block 144, from FIG. 4. As depicted in FIG. 5, this step is essentially a process loop, as indicated by blocks 146, 148, that is repeated a number of times until the construction of the article is complete. In each iteration of the process loop, a layer of the article or articles is constructed.

In this process loop, the first process step, block 150, is to perform ray casting to the model or models to calculate all locations that are to be printed for the layer. The second process step, block 152, is to apply the layer data generated in the previous step, block 150, to the printing mechanism of the solid free-form fabrication machine. In other words, this step, block 150, provides printing instructions to the printing mechanism for the layer. In the third process step, block 154, the solid free-form fabrication machine uses the printing instructions to fabricate a layer of the article or articles. The loop consisting of first, second, and third process steps, blocks 150, 152, 154, is repeated for each layer until there are no more layers to be fabricated. These three process steps may occur sequentially or may overlap in time. In some embodiments in which the layer data and/or the printing instructions had been stored for subsequent use, a step of recalling the layer data or printing instructions from memory is used instead of the first step, block 150.

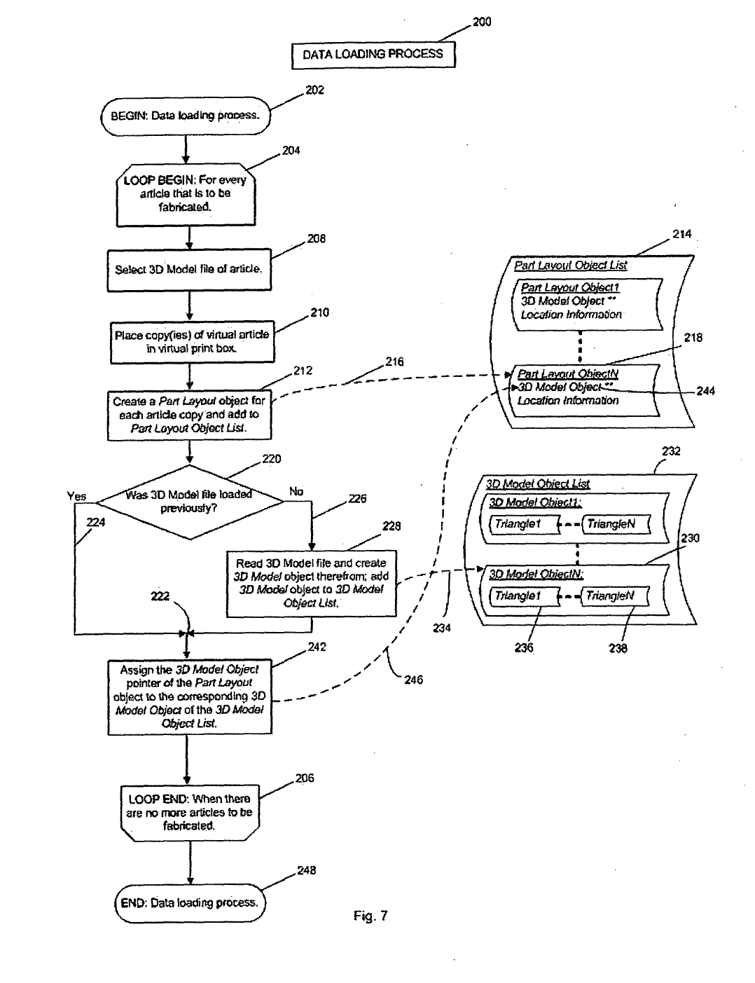

FIGS. 7-14 depict in much greater detail the process depicted in FIG. 5 for some particularly preferred embodiments of the present invention. These figures describe a series five process steps which are performed in the construction of each layer of the article or articles. They also include a depiction of an initialization step, which precedes the five-step series, in which the data representing the model or models of the article or articles are loaded into memory. In the description of these preferred embodiments, the model or models created in second process step, block 142 of FIG. 4, are referred to as “3D model data files.” Also in this description, each 3D model data file is an STL file in which the physical article is represented as a set of triangles having surface normals which indicate which surface of the triangle is facing outward from the surface of the article. Note that where such a surface is an internal surface of the article, e.g., one surrounding an internal cavity, the surface normal points outwardly from the internal surface, e.g., into the internal cavity.

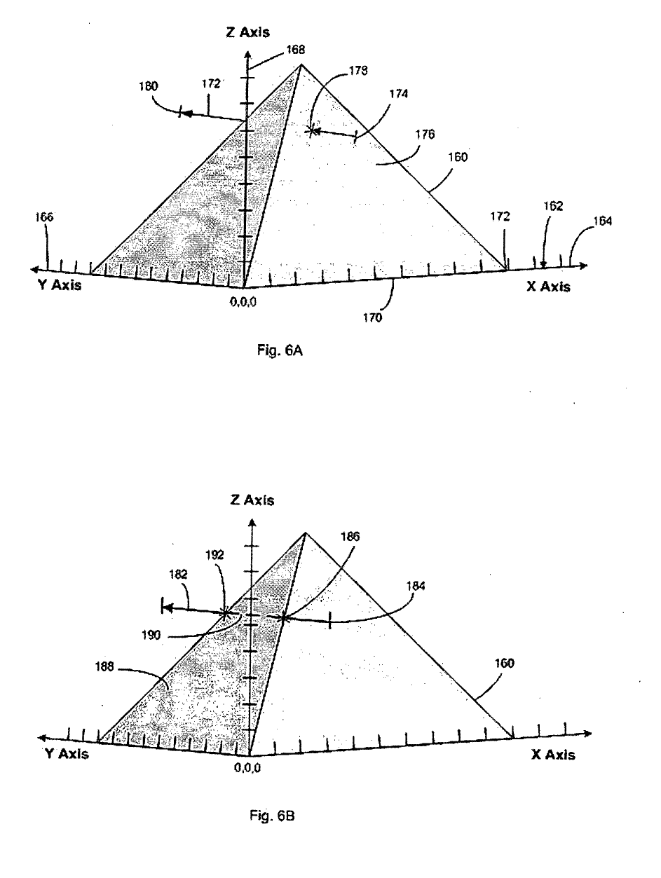

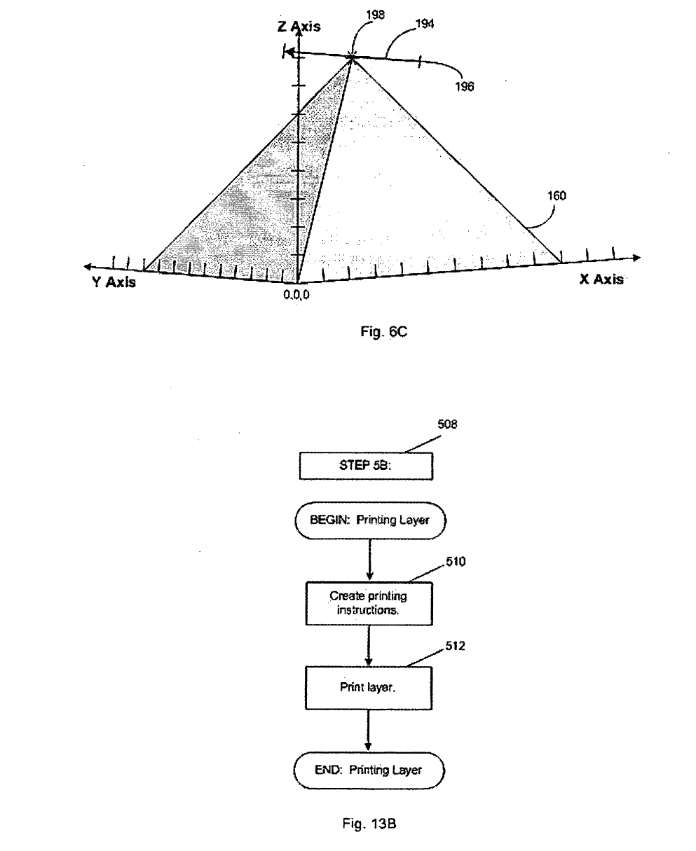

Also in this description, the coordinate system has been chosen so as to have its base plane coincident with that of the virtual print box and its origin coincident with the home position of the printing mechanism. This arrangement is illustrated in FIGS. 6 A-C. However, there is no limit on the number of other arrangements that are possible and that are within the skill of the ordinary person skilled in the art to utilize with regard to coordinate system selection and implementation for embodiments of the present invention.

The initialization step is shown in the flow chart presented in FIG. 7. To conserve memory and computational resources, the model for each physical article is loaded only once, regardless of the number of copies of that article that will be fabricated at the same time. Where more than one copy of the physical article is to be fabricated at the same time, information is stored about the location and orientation of each copy in the virtual print box. The Z-extents of each copy are also stored for use in determining whether or not any part of the copy exists on a particular layer that is being constructed. The term “extent” is a term of art which refers to the value range of a geometric object with regard to a particular coordinate axis. For example, a geometric object's Z-extents are the range of Z-values among the point coordinates of the geometric object.

Referring to FIG. 7, the initialization step, title block 200, consists of loading the 3D model data file or files into memory which is accessible by the computer processor of solid free-form fabrication machine. During the initialization step, the 3D model data file or files are loaded and then saved as internally stored objects and internal lists. Block 202 indicates the beginning of the data loading process. A processing loop is begun as indicated by block 204. In each iteration of this processing loop, a 3D model data file is loaded. As indicated by block 206, the looping is terminated when there are no more 3D model data files to process.

As indicated by block 208, a 3D model data file corresponding to an article to be made is selected by the user in the first step of the loading loop. The user may then virtually place the article represented by the 3D model data file at a selected location within a virtual space volume that corresponds to the print box, i.e., into a virtual print box. Alternatively, this placement may be done by a routine that determines a placement location based upon preselected or input criteria. Such a placement routine is within the skill of one of ordinary skill in the art and will not be described further. Regardless of the method used for placement, a particular article may be virtually placed in one or more locations within the virtual print box, depending on how many copies of the article are to be made, as indicated by block 210.

After the placement substep, block 210, has been completed for a particular 3D model data file, a data object is created for each copy of the article. The data object includes information about the location of the copy within the virtual print box. In this description, these data objects are given the title “Part Layout” objects. The creation of the Part Layout objects is indicated by block 212. After a Part Layout object has been created, it is added to a data object list, e.g., the Part Layout Object List, block 214. This is indicated in FIG. 7 by the dashed arrow 216 extending from block 212 to the Part Layout ObjectN block 218 within the Part Layout Object List, block 214.

Next, a decision point, block 220, is encountered at which it is necessary to determine if the 3D model data file that was selected in this iteration had been previously loaded. If it had been previously loaded, then the process skips down to junction point 222 along flow route 224. Otherwise, the process continues along flow route 226 to the substep indicated by block 228. In this substep, the 3D model data file is read and loaded into memory by creating a data object, e.g., 3D Model DataN, block 230, for the 3D model data file. The data object is added to a data list, e.g., the 3D Model Object List, block 232, as is indicated by dashed arrow 234 extending to block 230 within block 232. The data object comprises data describing the geometric components of which the 3D data model is composed. In this description, the geometric components are the individual triangles of the STL file representation of the model and their surface normals and are sequentially named “Triangle1” through “TriangleN”, e.g., blocks 236, 238. After the completion of the substep, block 228, the process flows along flow route 240 to junction point 222.

In the next substep, block 242, a connection is set up between the 3D model data file, e.g., 3D Model Object1, block 230, and each of its Part Layout data objects, e.g., Part Layout ObjectN, block 218. This is done by assigning a pointer, e.g., pointer 3D Model Object** 244, in each Part Layout object to its corresponding 3D model data file. This is depicted in FIG. 6 by dashed arrow 246 extending from block 242 to 3D Model Object** 244 in block 218.

At the completion of this substep, block 242, the process goes to the end of the loop or iteration, block 206, to determine if any more articles are to be fabricated. If there are, the process returns to the loop beginning, block 204, for another iteration. If there are not, then the Data Loading Process, block 200, terminates at block 248.

With the 3D model data files and their locations within the virtual print box stored in memory, the process loop of five steps that are conducted for each build layer is begun. These five steps are briefly identified as:

Step 1—Identifying first the 3D model data files and then their geometric components whose extents intersect the layer.

Step 2—Positioning of the identified geometric components within the layer.

Step 3—Creating and casting rays across the layer.

Step 4—Calculating the locations of the intersections of rays with the geometric components in the layer; note that Step 4 is embedded within Step 3.

Step 5—Creating a data set of printing mechanism instructions from the intersection information.

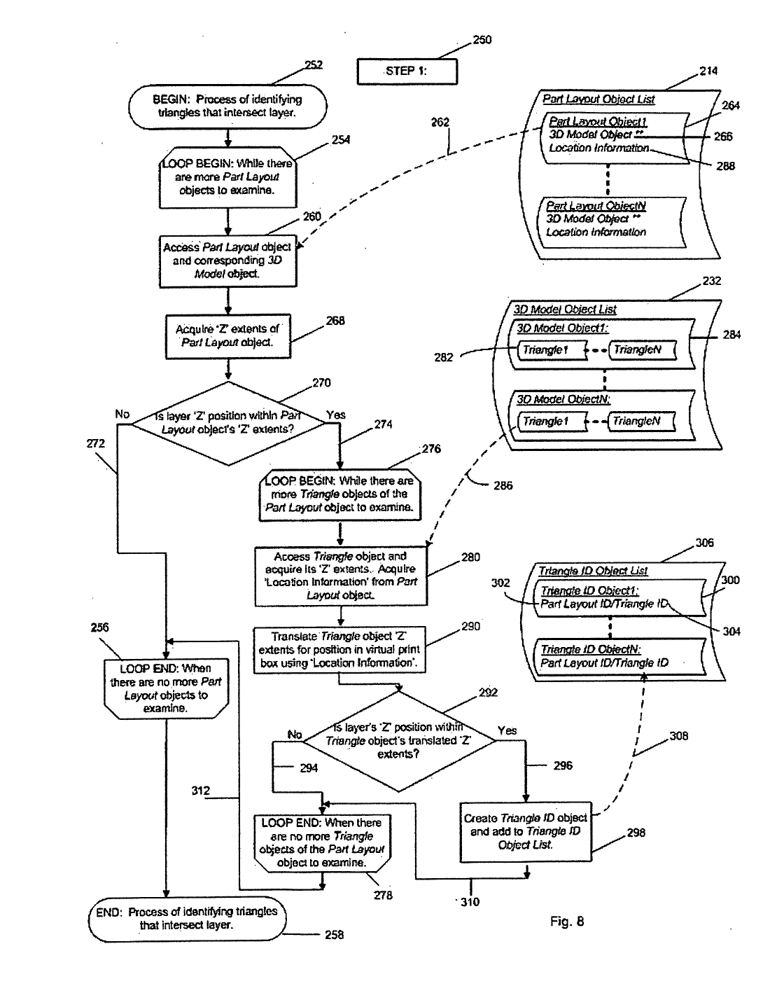

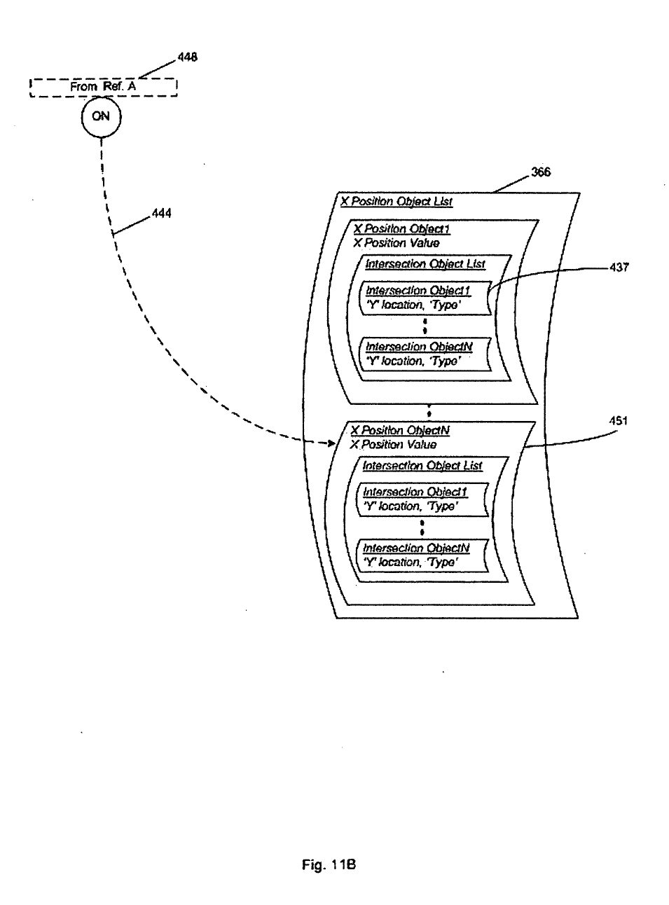

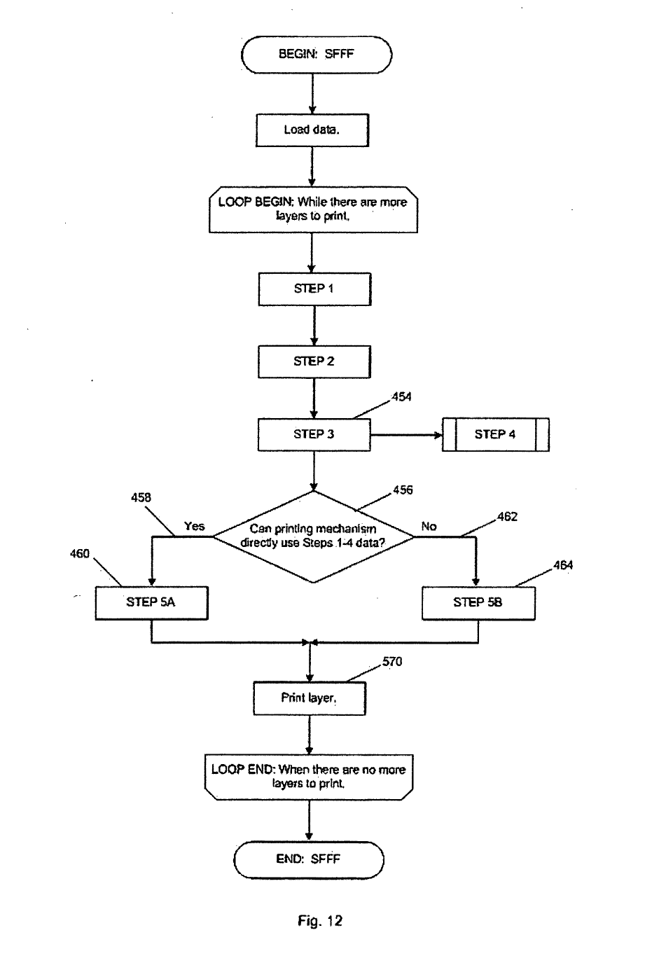

During Steps 1-5, the data that was stored in memory in the initialization step is examined to determine the printing instructions that are needed for the layer. Because the coordinate system was chosen to have its base plane coincident with the base plane of the virtual build box, each layer is conveniently located at a particular Z-plane, i.e., a plane of points whose Z-coordinates are all the same. Also, the origin of the coordinate system was chosen to coincide with the home position of the printing mechanism. The X-direction was taken as the direction along which the printing mechanism travels and the Y-direction as the direction along which the printing mechanism prints. This greatly simplifies the calculations needed to carry out the process. Steps 1-5 define a loop that is repeated for each layer of construction as is shown in FIG. 12. This loop is terminated either when the top of the virtual build box is reached or when a height is reached in the virtual build box above which there is nothing left to build. Steps 1-5 will now be described in more detail with reference to FIGS. 8-12.

The purposes of Step 1 are to: (1) determine which of the articles intersect the layer; (2) identify which of the geometric components of those articles intersect the layer, and (3) construct a list of identifiers for each of those geometric components. Step 1 is useful in that it speeds up the overall process by eliminating the need to further examine 3D model data files and the geometric components of the articles that lie completely outside of the layer. Nonetheless, it is not employed in many embodiments of the present invention.

FIG. 8 contains a flowchart representation of Step 1. Step 1, title block 250, is initiated at block 252 and is carried out as a loop between blocks 254, 256. This loop is repeated until there are no more Part Layout objects to examine, at which time it terminates at block 258.

In the first substep, block 260, the Part Layout List file, block 214, is accessed to obtain the first Part Layout data object stored therein. This is indicated by the first dashed arrow 262 extending to the first part layout data object, Part Layout Object1, block 264, located within the Part Layout Object data list, block 214. The corresponding 3D model data file data is also accessed by way of the pointer contained within the Part Layout data object, i.e., 3D Model Object** 266.

In the next substep, block 268, the Z-extents are acquired from the Part Layout object which was accessed in the preceding substep, block 260.

A decision point, block 270, is next encountered at which it is determined whether or not the Z-position of the layer, i.e., the Z-coordinate of the layer, is within the Z-extents acquired in the preceding substep, block 268. In other words, it is determined whether or not the Z-plane of the layer intersects the copy of the article that corresponds to the Part Layout object. If there is no intersection, then the process moves onto another iteration of the blocks 254, 256 loop as indicated by process route 272 going to block 256. If there is an intersection, then the process path along process route 274 is followed to the beginning of a subloop bracketed between blocks 276, 278. The effect of this decision is to eliminate from further examination, with regard to this layer, all of the individual geometric components that make up the copy of the article that corresponds to the Part Layout object if none has Z-extents that lie within the layer.

In the subloop between blocks 276, 278, each of the geometric components of the 3D model data file which corresponds to the Part Layout object is sequentially examined to determine if it has Z-extents within the layer's Z-position. A list is made of those geometric components that do lie within the layer's Z position.

Thus, in the first substep, block 280, of this subloop, the Z-extents of a first geometric component, e.g., Triangle 1, block 282, in the 3D model data file, e.g., 3D Model Object1, block 284, are acquired from the 3D Model Data List, block 232, as is generally indicated by dashed arrow 286. Information about the location and orientation of the article copy, e.g., Location Information 288 for Part Layout Object1, block 264, are also acquired by reference to the Part Layout object acquired previously in block 260.

In the next substep, block 290, of this subloop, the Z-extents of the geometric component within the virtual print box are determined. This is accomplished by translating the Z-extents acquired in the previous substep, block 280, through the use of the location and orientation information also acquired in that substep. In other words, the Z-extents of the geometric component are adjusted to take into account the geometric component's position within the virtual print box.

A decision point, block 292, is then reached at which it is determined whether or not the Z-position of the layer is within the translated Z-extents of the geometric component under consideration. If it is not, then that geometric component is given no further consideration and the subloop is repeated for the next geometric component as is indicated by process route 294 extending to block 278. If it is, then the process continues along process route 296 to the next substep, block 298, at which a data object is created to identify the geometric component, e.g., Triangle ID Object1, block 300. This data object includes information about the identification of the corresponding Part Layout object, e.g., Part Layout ID 302, and about the identity of the geometric component, e.g. Triangle ID 304. This data object is stored in a list, e.g., Triangle ID Object List, block 306, as is generally indicated by dashed arrow 308.

The process continues along process route 310 to process route 294 and onto the loop end, block 278. If there are any more geometric components to be examined, the subloop between blocks 276, 278 is repeated. If there are not, then the process continues along process route 312 to process route 272 and then to block 256, thus ending an iteration of the major loop of Step 1, i.e., between blocks 254, 256. The major loop is repeated until there are no more Part Layout objects to be examine, at which time, the Step 1 process continues along process route 294 to its termination, block 258, and the overall process moves on to Step 2.

Step 2 is performed in the embodiments of the present invention in which Step 1 is used. The purposes of Step 2 are to: (1) position in the virtual print box each of the geometric components that were identified in Step 1 as intersecting the layer; and (2) create a list of those geometric components. In other words, a virtual layer of the virtual print box is created in Step 2 containing all of the geometric components which have Z-extents in that layer. This is done by creating a copy of each of the geometric components listed in the object list created in Step 1, e.g., Triangle ID Object List, block 306, and using its origin point to determine its position in the print box. A data object for the resulting positioned copy is then saved in a list.

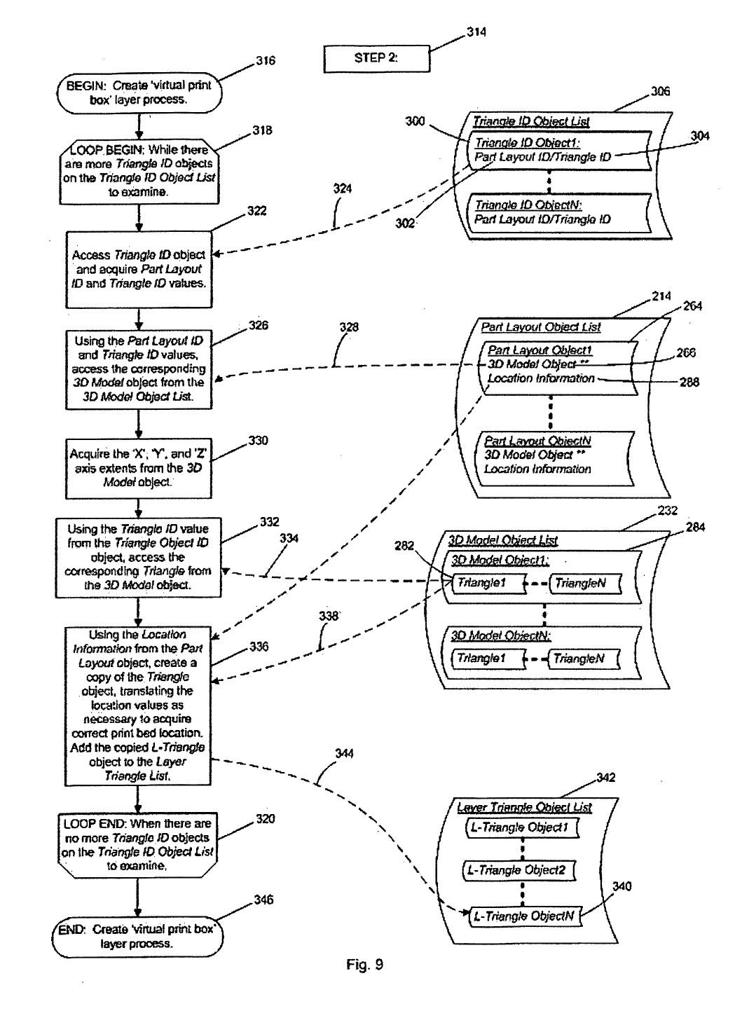

Referring to FIG. 9, Step 2, title block 314, commences at initiation block 316. Step 2 consists of a process loop between blocks 318, 320. In each iteration of the loop, a data object in the geometric component list created in Step 1 is examined, i.e., Triangle ID Object List, block 306. The loop is continued until there are no more data objects in the list, e.g., block 306, left to be examined.

The first substep of the loop is shown in block 322. In this substep, a first data object, e.g., Triangle ID Object1, block 300, is accessed as is generally indicated by dashed arrow 324. During this access, information corresponding to that data object is acquired, e.g., Part Layout ID 302, and Triangle ID 304.

In the second substep, block 326, the information acquired in the preceding substep, block 322, is used to access the corresponding 3D model data object. This is done by first accessing the Part Layout Object List, block 214, to determine the corresponding pointer, e.g., 3D Model Object** 266 for Part Layout Object1, block 264, as is generally indicated by dashed arrow 328. The pointer is used to access the corresponding 3D model data file object, e.g., 3D Model Data1, block 284, in the 3D Model Data List, block 232.

In the third substep, block 330, the 3D model data file object accessed in the previous step, block 326, is examined to determine its X-, Y-, and Z-extents.

In the fourth substep, block 332, the information acquired in the first substep, block 308, is used to the access the information about the geometric component. For example, the Triangle ID value 304 from Triangle ID Object1, block 304, is used to access the geometric component Triangle 1, block 282, of 3D Model Object1, block 284, within the 3D Model Object List, Block 232. The accession is generally indicated by dashed arrow 334.

In the fifth substep, block 336, a copy of the data object related to the geometric component is created. This is done, for example, by accessing the Location Information 288 from Part Layout Object1, block 264, and using this in conjunction with the information about Triangle1, block 282, that was acquired in the previous substep, block 332, to create the copy, as is generally indicated by dashed arrow 338. In making the copy, its location values are translated to locate the copy at the position it is to have in the virtual print bed. The created copy is then added to a list of the geometric components for the layer, e.g., as the data object L-TriangleN, block 340, in the Layer Triangle List, block 342, as is generally indicated by dashed arrow 344.

After the fifth substep, block 336, has been completed, the process moves the iteration on to the end of the loop, block 320. If there are more geometric components, e.g. any more objects in Triangle ID Object List, block 306, to be examined, the loop is repeated by returning to block 304. If not, the Step 2 process moves on to its termination at block 346 and the overall process advances to Step 3.

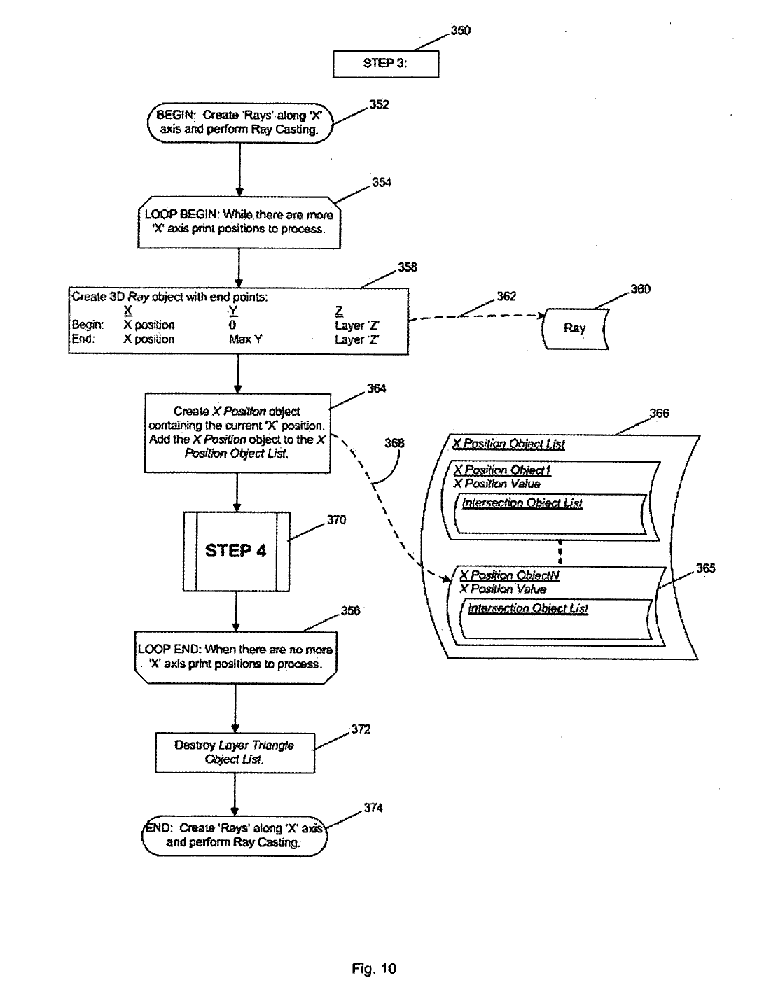

Steps 3 and 4 are intimately related as Step 4 is a subroutine within Step 3. This is shown in FIG. 10. Together, these two steps accomplish the ray casting and generate the locations at which printing is to be done. The ray casting is performed from the Y=0 point in the layer's Z-plane for each printing mechanism position along the X-axis. Each ray is cast across the entire range of Y-values for the corresponding X-axis value of the ray's origination point. Use of this scheme greatly simplifies the process, although not all embodiments of the present invention utilize this scheme.

Referring to FIG. 10, Step 3, title block 350, commences at block 352, which indicates that the step includes creating rays with origination points on the X-axis and performing ray casting. Step 3 comprises a loop that extends between blocks 354, 356. In each iteration of this loop, a ray is cast for single X-axis print position. The loop is repeated until there are no more X-axis print positions to be processed for the layer.

In the first substep, block 358, a ray object is created having its origination point at X=xᵢ, Y=0, and Z=z of the layer's Z-plane, where xᵢ is the X-value being addressed in the loop iteration. The virtual ray associated with the ray object extends across the entire range of Y-values of the layer at xᵢ so that its end point is X=x, Y=yₘₐₓ, Z=z of the layer's Z-plane, where yₘₐₓ is the highest Y-value for the layer at xᵢ. The created ray object is placed into memory as “Ray,” block 360, as is indicated by dashed arrow 362.

In the next substep, block 364, a data object is created, e.g., data object X Position ObjectN, block 365. This data object contains the X-value being addressed by the loop iteration. This data object is added to a list, e.g., the X Position Object List, block 366, as is generally indicated by dashed arrow 368.

Step 3 then proceeds into the Step 4 subroutine, block 370, which is described in detail below. Upon exiting the Step 4 subroutine, block 370, the Step 3 process iteration proceeds to loop end block 356. If there is another X-axis print position to be processed, the Step 3 process returns to loop start block 354 to perform another loop iteration. Otherwise, it proceeds onto the next substep, block 372, at which the list of geometric components in the layer, i.e., the Layer Triangle Object List, block 342 of FIG. 9, is destroyed. However, this list may be retained for future use, if so desired. Step 3 then terminates at block 374.

Step 4 is the step in which the ray casting is performed to determine the intersection points of the virtual ray with the geometric components that intersect the Z-plane of the layer. This ray casting is done through the use of well-known geometric formulas for determining the intersections of rays and geometric components. As the geometric components are triangles in this description and the ray is a line segment, this step also involves differentiating among three types of triangle/line segment intersections: (1) intersections where the ray intersects a triangle at a point on its face; (2) intersections where the ray intersects a triangle along a line segment across the triangle's face; and (3) intersections where the ray intersects a triangle at a vertex. These three types of intersections are referred to hereinafter and in the appended claims, respectively, as: (1) simple intersections; (2) planar intersections; and (3) vertex intersections. The intersection type is used in determining the printing instructions for the layer. These three types of intersections are illustrated in FIGS. 6 A-C.

Referring to FIG. 6A-C, in these figures, the physical article to be made is a pyramid 160. Each of these figures shows a coordinate system 162 having an X-axis 164, a Y-axis 166, and a Z-axis 168, all of which are mutually orthogonal. In each of the figures, the pyramid 160 has its base plane 170 within the base plane of the coordinate system 162. In these figures, the intersection points are emphasized by depicting them by an asterisk-like element. In each of these figures, the direction of the ray is parallel to the positive direction of the Y-axis.

FIG. 6A illustrates a simple intersection. In this figure, the ray 172 has an origination point 174. The ray 172 first intersects first triangle face 176 of pyramid 160 at a point 178.

Although not visible in FIG. 6A, the ray 172 also intersects a triangle at a point on the backside of the pyramid 160 where the ray 172 exits the pyramid 160. That intersection is also a simple intersection. Ray 172 terminates at point 180.

FIG. 6B shows an example of a planar intersection. In this figure, the ray 182 has an origination point 184. The ray 182 initially intersects the pyramid 160 at a first point 186 and continues to intersect the pyramid 160 across the second triangle face 188 along a line segment 190 that terminates at second point 192.

FIG. 6C illustrates a vertex intersection. In this figure, the ray 194 has an origination point 196. The ray 194 intersects the pyramid object 160 at vertex 198. Note that vertex 198 is shared by the four triangular faces of pyramid 160.

In the preferred embodiments of the present invention that are being described, the ray/triangle intersections are stored as data objects within a data structure representing a particular X-position for the layer. Each intersection data object includes the Y-value of the intersection point as well an indication as to whether, at the intersection point, the ray is entering or exiting the interior of the physical object represented in part by the triangle. Where the ray is entering, an “ON” designation is used. Where the ray is exiting, an “OFF” designation is used. Where the ray intersects the triangle at a single point, e.g., at a vertex or edge, then the ray is both entering and exiting at the same time. This special case is given the designation of “POINT.” As described above, a unit normal of the intersected geometry item surface is used to make the entering/exiting determination.

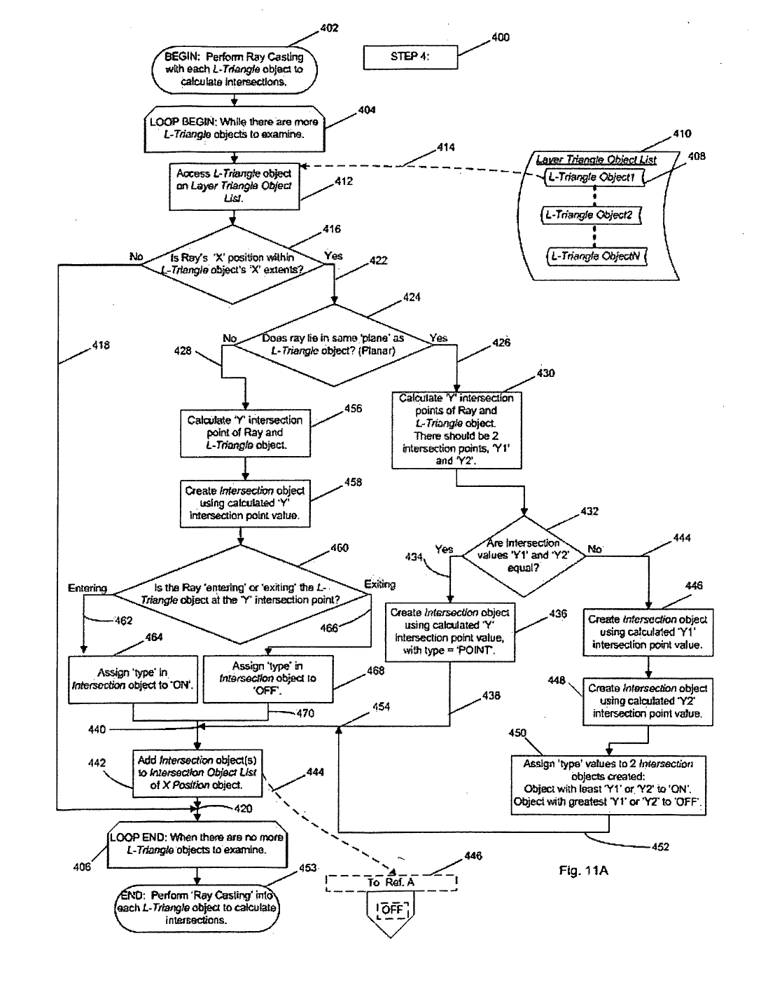

Referring to FIG. 11A, Step 4, title block 400, commences at block 402. This step comprises a loop that extends between blocks 404, 406. During each loop iteration, a particular geometric component, e.g., L-Triangle Object1, block 408, from the list of geometric components in that layer, e.g., Layer Triangle Object List, block 410, is examined for intersections with the ray created in the current Step 3 iteration. The loop is repeated until there are no more geometric components left to examine.

In the first substep, block 412, a data object describing a geometric component, e.g., L-Triangle Object1, block 408, is accessed as is generally indicated by dashed arrow 414.

At the first decision point, block 416, it is determined whether or not the X-position of the ray data object created in Step 3 is within the X-extents of the geometric component, e.g., Triangle Object1, block 408, accessed in the preceding substep, block 412. If it is not, then there is no intersection between the ray and the geometric component and so the process moves on to another iteration of the Step 4 loop as indicated by the process route 418 going to junction point 420 and then onto block 406. If it is, then there is an intersection between the ray and the geometric component and so the process route 422 is followed to a second decision point, block 424. Since there is an intersection in that case, it is necessary to determine what type of intersection it is.

At the second decision point, block 424, it is determined whether or not the ray lies within the same plane as the geometric component. In other words, it is determined whether or not the ray intersects more than one of the perimeter sides of the triangular geometric component. If it does, the process route 426 is followed. If it does not, then the process route 428 is followed. The process route 426 process is described first.

Process route 426 terminates at a substep represented by block 430. The determination made in block 424 that the ray intersects more than one of the three perimeter sides of the triangular geometric component necessarily implies that two, and only two, of the triangle's perimeter sides are intersected. In this process substep, block 430, the Y-values of these two intersections are calculated and identified as “Y1” and “Y2.” Because all of the X-values and Z-values are constant for a ray under Step 4 consideration, only the Y-values of the intersections points need to be identified.

At the third decision point, block 432, a determination is made as to whether or not Y1 and Y2 are equal. If they are, then the two sides that were intersected by the ray were intersected at their common point, i.e., a vertex of the triangular geometric component. When that is the case, the process route 434 is followed to block 436. In that process substep, block 436, a single data object is created to represent both of the intersection points, e.g., data object “Intersection” (see, e.g., block 437 of FIG. 11B). This data object includes the Y-value of the intersection and an indicator that the intersection is of the POINT type. The process then continues along process route 438 to junction point 440 and then to block 442, which is described below.

Where Y1 and Y2 were not found to be equal in block 432, then it must be that the ray intersects the triangular geometric component along a line segment across its face. When that is the case, the process route 444 followed to block 446. In this process substep, block 446, a first data object is created using the Y1 value to represent the first intersection. The process then goes to the next process substep, block 448, at which a second data object is created using the Y2 value. In the next process substep, block 450, the intersection types are added to these two data objects. For the data object corresponding to the intersection having the lesser Y-value, the type “ON” is assigned. The intersection type “OFF” is assigned to the other data object. The process then continues along the process route 452 to junction point 454 and then along the process route 438 to the junction point 440 and then onto block 442. Before describing what happens at block 442, this description first returns to the decision block 424 to describe the process the iteration takes when it is determined that the ray intersects only one of the perimeter sides of the triangular geometric component.

As mentioned above, when it is decided in block 424 that less than two sides of the triangular geometric component is intersected by the ray, process route 428 is followed. This determination means that line segment intersects the triangular geometric component at a single point somewhere upon a face of the triangular geometric component.

The first substep encountered is represented by block 456. In that substep, the Y-value of the intersection is calculated. The process then goes to the next substep, block 458, wherein a data object is created to represent the intersection using the Y-value calculated for the intersection. Another decision block 460 then is encountered. At this decision block, it is determined whether or not the ray is entering or exiting the triangular geometric component. If it is found to be entering, process route 462 is followed to block 464 at which the intersection type ON is assigned to the data object. If the ray is found to be exiting, then process route 466 is followed to block 468 at which the intersection type OFF is assigned to the data object. Process route 470 is followed from either of blocks 464, 468 to block 442.

At the process substep, block 442, following either process path from decision block 424, the data object or data objects to describe the intersection or intersections, e.g., objects labeled “Intersection”, are added to a list within the X position data object, block 366, which was created in Step 3. This is generally indicated by the dashed arrow 444 extending to the off page reference, block 446. The corresponding on-page reference, block 448, is found in FIG. 11B. There dashed arrow 444 is continued to a data object, e.g., X Position ObjectN, block 451, within X Position Object List, block 366.

Referring again to FIG. 11A, after the block 442 substep, the process continues through junction point 420 to the end of loop, block 406. If there are any more geometric components, e.g., an L-Triangle object, to be examined for the layer, another iteration is performed for the loop, blocks 404, 406. If there are not, then the Step 4 process ends at block 453 and Step 3 is resumed at block 356 of FIG. 10.

After all of the Step 3 iterations have been completed for the layer, all of the information necessary for printing the layer has been collected. However, while some printing mechanisms may be able to use the data structures described so far for their printing instructions, others require further manipulation of the data. The flow chart in FIG. 12 illustrates this. The flow chart of FIG. 12 is a refinement of the flow chart in FIG. 5 presented in terms of the steps of the embodiment of the present invention that is being described. Referring to FIG. 12, it is seen that Step 3, block 454, is followed by a decision point, block 456, at which a determination is made as to whether or not the printing mechanism can use the data structures created in Steps 1-4 for its printing instructions. If it can, then the process moves along process route 458 to Step 5A, block 460, for the printing of the layer. If not, then the process moves along process route 462 to Step 5B, block 464 for creating a set of printing instructions and then printing the layer. The Step 5A option will be discussed first.

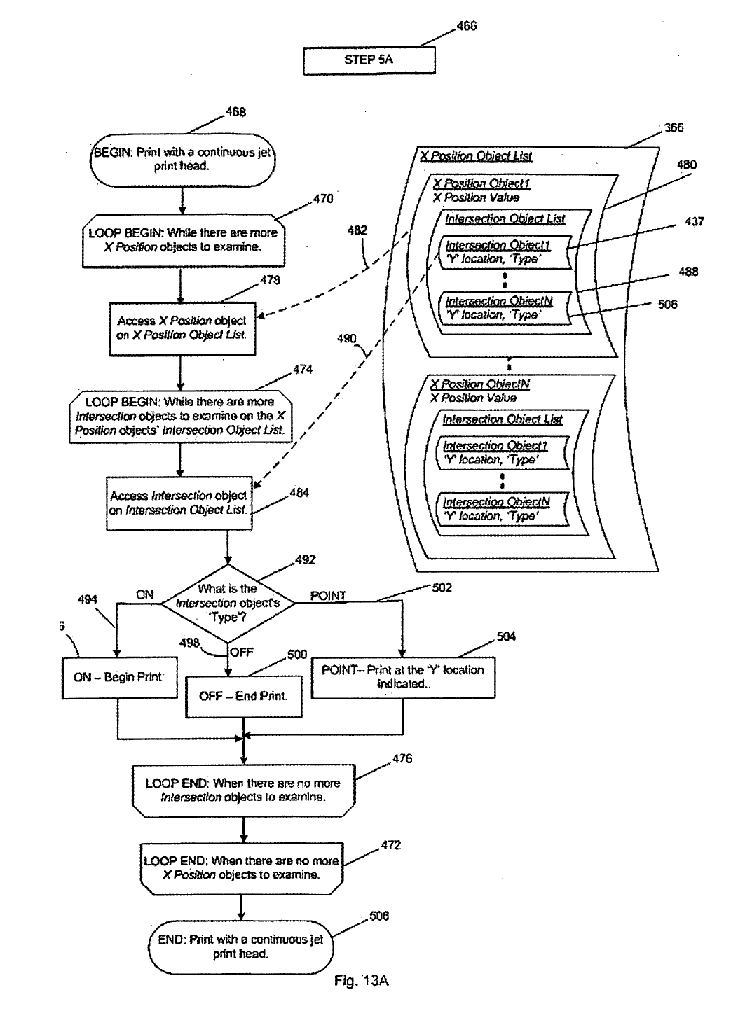

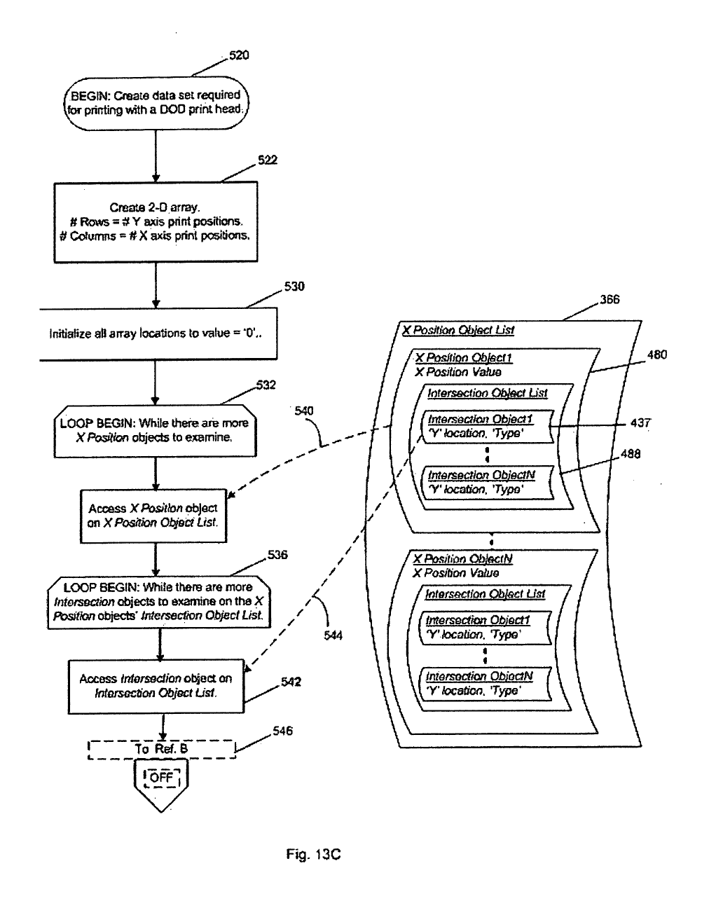

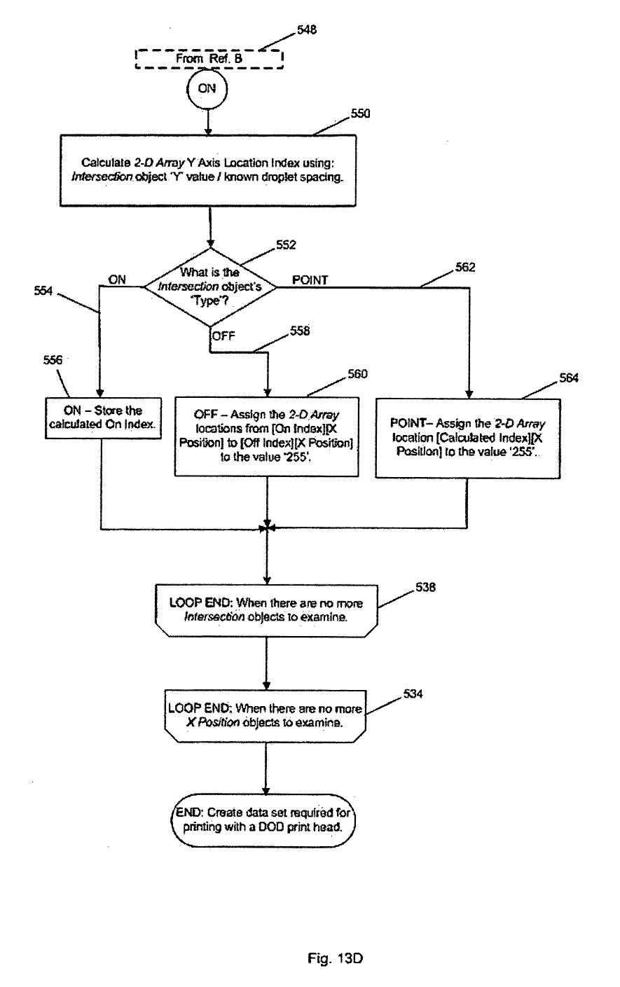

Referring to FIG. 13A, Step 5A, title block 466, there is set forth a process for creating a data set required for a printing mechanism that uses continuous printing, e.g., a continuous jet printhead, as indicated in block 468. Step 5A comprises an outer loop bracketed by blocks 470, 472, and an inner loop bracketed by blocks 474, 476. In each iteration of the outer loop, the ray/geometric component intersection data created in Steps 3 and 4 are examined for a particular X position. This outer loop is repeated until there are no more X positions to examine. In each iteration of the inner loop, a particular intersection is examined and used to cause the printing mechanism to print. This inner loop is repeated until there are no more ray/geometric component intersections left to examine.

At the first process substep, block 478, of the outer loop of Step 5A, the first print head X position, e.g., X Position Object1, block 480, is accessed from a list, e.g., X Position Object List, block 366, as is generally indicated by dashed arrow 482. The first iteration of the inner loop is then begun, as is designated by block 474. The first process substep, block 484, within the inner loop is to access information about a ray/geometric component intersection, e.g., Intersection Object1, block 437, on the intersection data list, e.g., Intersection Object List, block 488, within the data X position data object, e.g., X Position Object1, block 480, as is generally indicated by dashed arrow 490. A determination is then made at decision block 492 as to which of the three types of intersections is described by the data object. If the intersection type is ON, then the process goes along process route 494 to block 496 and the printing mechanism is instructed to begin its printing at that location. If the intersection type is OFF, then the process goes along process route 498 to block 500 and the printing mechanism is instructed to turn off its printing at that location. If the intersection type is POINT, then the process goes along process route 502 to block 504 and the printing mechanism is instructed to print at the location by turning on and then off.

After a printing instruction is made in any of blocks 496, 500, 504, the process proceeds to inner loop end block 476. If there is another ray/geometric component intersection to examine for the X position, e.g., Intersection ObjectN, block 506, the inner loop is repeated. Otherwise, the process proceeds to outer loop end block 472. If there is another X position to examine, the outer loop is repeated. Otherwise, it proceeds to block 506 to end Step 5A.

Now turning to the Step 5B alternative, it is to be understood the particular process of creating printing instructions in this step will depend on the particular printing mechanism that is to be employed. FIG. 13B depicts an example of a Step 5B process that is suitable for use with a printing mechanism that requires a specific on/off command to be assigned to every cell of the layer, e.g., a drop-on-demand (“DOD”) type of printing mechanism. In the Step 5B process described, a two-dimensional array is created for a layer. In the array, each cell represents a print cell location for the layer. Each cell is assigned a code that instructs the printing mechanism to either print or not print at the corresponding layer cell.

Referring to FIG. 13B, Step 5B, title block 508, begins at block 510. In this substep, the data set that is to be used for the printing instructions is created. At the second process substep, block 512, the printing instructions are utilized by the printing mechanism to print the layer. The details of the second process substep, block 512, are particular to the particular printing mechanism and are within the skill of a person of ordinary skill in the art to create. Those details will not be discussed. However, an example of the printing instruction creation substep, block 510, is discussed below and is depicted in FIGS. 13C-D.

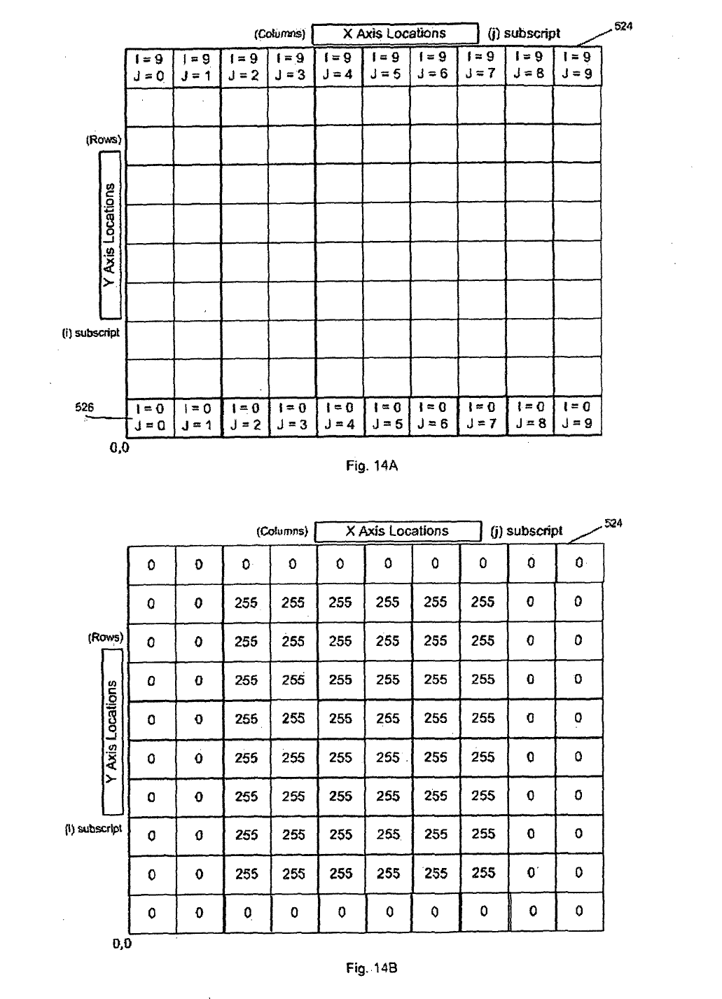

Referring to FIG. 13C, the beginning of the example of a printing instruction creation process is indicated by block 520. At first process substep, block 522, a two dimensional array is created. The number of rows in the array is the number of Y-axis print positions for the printing mechanism in the layer and the number or columns is the number of X-axis print positions for the printing mechanism in the layer. An example of such an array is depicted in FIGS. 14A-B.

Referring to FIG. 14A, there is shown there an array 524. The array 524, has columns corresponding to X-axis locations of the printing mechanism in the layer and rows corresponding to the Y-axis locations of the printing mechanism for the layer. The origin 526 for the array 524 is the lower left corner cell. The cells are identified by their row and column coordinates, with an “i” subscript being used to designate the row number and a “j” subscript being used to designate the column number. Cell identifications are given in the top and bottom rows for illustration purposes only and do not represent values in those cells.

Referring again to FIG. 13C, in the second process step, block 530, the values of each of the cells in the array is set to zero. The process then proceeds onto a set of two nested loops. The outer loop is bracketed by block 532 and block 534 (shown in FIG. 13D). The inner loop is bracketed by block 536 and block 538 (shown in FIG. 13D). In each iteration of the outer loop, a print head X position, e.g., X Position Object1, block 480, is accessed from a list, e.g., X Position Object List, block 366, as is generally indicated by dashed arrow 540. The inner loop then begins at block 538. In the first substep, block 542 of the inner loop, information is accessed about a ray/geometric component intersection, e.g., Intersection Object1, block 437, on the intersection data list, e.g., Intersection Object List, block 488, within the data X position data object, e.g., X Position Object1, block 480, as is generally indicated by dashed arrow 544. The process then proceeds through the off-page reference, block 546, to the on-page reference, block 548, in FIG. 13D.

Referring to FIG. 13D, at the next substep, block 550, the printing location along the Y-axis is calculated using the Y value of the ray/geometric component intersection divided by width of a print cell where that width is measured in terms Y-axis units. In this way, the row index number for the cell in the array is determined for the ray/geometric component intersection, i.e., the Y Location Index of the cell in the array 524 in FIG. 14A.

At decision block 552 the intersection type is assessed. If it is an ON type, then process route 554 is followed to substep block 556 and the Y index value of the cell is temporarily stored. If it is an OFF type, then process route 558 followed to substep block 560. At that substep, print instruction values are assigned to one or more cells in the array for the column associated with the X position being addressed in the outer loop. The cells to which print instruction values are assigned are those having Y-index values equal to or greater than the Y-index value of the latest stored ON intersection, if any, to the Y-index value of the of the current OFF intersection. Each of those cells, if any, are assigned a value that indicates printing is to occur in the locations associated with those cells, e.g., a value of 255. If at decision block 552 the type is found to be POINT, then process route 562 is followed to substep block 564. At that substep, the cell having an X-index associated with the X position being addressed in the outer loop and a Y-index associated with the current POINT intersection is assigned a value that indicates printing is to occur at the location associated with that cell, e.g., a value of 255.

At the conclusion of whichever of the substeps blocks 556, 560, 564, was taken from decision block 552 for the particular iteration, the process continues to loop end block 536. Another iteration of the inner loop is performed if there are any more ray/geometric component intersection data objects left to examine. If not, then the process continues on to the end of the iteration of the outer loop, block 534. If there are any more print head X positions to evaluate, then another iteration of the outer loop is performed. If not, then the step of creating printing instructions, e.g: block 510 of FIG. 13B concludes.

FIG. 14B shows an example of the array 524 of FIG. 14A at the conclusion of the process described in FIGS. 13C-D for a layer in which a square is to be printed. In this example, cells corresponding to locations where no printing is to occur retain their initialized values of 0. Cells which correspond to locations where printing is to occur have been reassigned the value of 255.

Referring again to FIG. 12, at the completion of either Step 5A or Step 5B the process moves on to substep block 570 at which the layer is printed. The Step 1-Step 5 loop is then repeated until there are no more layers to be printed or otherwise processed.

In the preferred embodiments of the present invention just described, the ray casting was done from a plurality of x-positions on each layer that was to be printed and the rays were cast across the range of Y-values for the layer. However, the present invention is not limited to this single manner of ray casting, but rather includes all manners of ray casting wherein one or more rays are cast into an electronic representation of a physical object and information of the intersection between the ray or rays and the representations of features of the physical object are used as or for the generation of printing instructions for a solid free-form fabrication machine printing mechanism. Such printing instructions may be used immediately as they are generated or at a later time. The intersection information and/or the printing instructions generated may be stored in either volatile or permanent memory. The intersection information and/or the printing instructions generated may be used once or more than one time, either on a single solid free-form fabrication machine or on more than one solid free-form fabrication machines.

Some process embodiments of the present invention include a step of applying an error diffusion technique to the printing instructions that are generated as a result of applying ray casting. An error diffusion technique is a process that distributes printing instructions to a printing mechanism that has more than one printing device in a manner that lessens the effect of an individual printing device failing to print. Such failures result in unprinted areas where printing should have occurred and may detrimentally affect the structural integrity of the printed article. Three embodiments of error diffusion techniques that are among those embraced by the present invention are as follows.

In the first of these embodiments the start position of the printing mechanism for each layer is adjusted so that no two adjacent layers have the same start position. This results in a different printing device being assigned the responsibility to print vertically adjacent print cells, thus spacing out the unprinted cells.

In the second of these embodiments, the responsibility for printing along a particular X column of an array of printing locations for a layer is distributed among two or more printing devices. For example, the cells of the odd-numbered rows within a column may be assigned to printing device A and the cells of the even-numbered rows may be assigned to printing device B. Thus, the effect of a printing device, e.g., printing device A, to print will be diffused over a wider area, rather than be concentrated in a line along a column. In the third embodiment, the software makes a check of the availability of printing devices before the assignments of printing devices to particular array cells is done. If the software detects that a particular printing device is unavailable for printing, no printing assignments are made to that printing device, but rather are distributed among the remaining printing devices. In this way, all array cells are assigned to be printed only by printing devices which are determined to be functioning prior to the start of the printing of the layer.

It is to be understood that embodiments of the present invention also include methods which include a step of generating printing instructions in whole or in part for fabricating a physical object layer-by-layer by a solid free-form fabrication machine by performing ray casting into an electronic file representation of the physical object and a step of transferring those printing instructions to a solid free-form fabrication machine. For example, one computer system may be used to create a set of printing instructions and the printing instructions then may be transferred to a solid free-form fabrication machine for execution.

Process embodiments of the present invention may be used with any type of a solid free-fabrication machines. Preferred solid free-form fabrication machines include the 3DP process machines and SLS process machines. Solid free-form fabrication processes in accordance with the present invention can be used to produce articles comprised of metal, polymeric, ceramic, composite materials, and other materials.

The present invention also includes embodiments comprising systems having computer-readable instructions for producing an article layer-by-layer by a free-form fabrication machine from an electronic file representation of the article wherein the instructions describe a process for performing ray casting into the electronic file representation of the article to calculate locations to be printed by the free-form fabrication machine, with or without the application of an error diffusion technique. Such systems include solid-free form fabrication machines which contain such computer readable instructions. For example, the present invention includes embodiments wherein a 3DP system or a SLS system has such computer readable instructions.

The present invention also includes embodiments comprising computer-readable medium having computer instructions which are executable to produce an article layer-by-layer by a free-form fabrication machine from an electronic file representation of the article wherein the instructions describe a process for performing ray casting into the electronic file representation of the article to calculate locations to be printed by the free-form fabrication machine, with or without the application of an error diffusion technique. Such computer readable medium includes any kind of computer memory that now exists, e.g., including floppy disks, hard disks, CD-ROMS, Flash ROMS, nonvolatile ROM, and RAM, or may exist in the future.

While only a few embodiments of the present invention have been shown and described, it will be obvious to those skilled in the art that many changes and modifications may be made thereunto without departing from the spirit and scope of the invention as described in the following claims. All United States patents referred to herein are incorporated herein by reference as if set forth in full herein.

1. A method for producing an article layer-by-layer by a free-form fabrication machine from an electronic file representation of the article, the method comprising performing ray casting into said electronic file representation to determine at least one location to be printed by said free-form fabrication machine for fabricating said article.

2. The method of claim 1, further comprising the step of providing said electronic file representation in STL file format.

3. The method of claim 1, further comprising the step of providing said electronic file representation in a native format.

4. The method of claim 1, wherein said step of performing ray casting includes creating a data object containing information about an intersection between a cast ray and a virtual object generated from said electronic file representation and using said intersection information in determining at least one location to be printed.

5. The method of claim 4, wherein said intersection information includes a designation of the location of the intersection within a predefined virtual space.

6. The method of claim 5, further comprising providing said predefined virtual space with a coordinate system.

7. The method of claim 6, further comprising selecting said coordinate system from the group consisting of a Cartesian coordinate system, a cylindrical coordinate system, and a polar coordinate system.

8. The method of claim 4, wherein said intersection information includes a designation about whether the cast ray is entering or exiting a surface of the virtual object.

9. The method of claim 1, wherein said step of performing ray casting includes casting a plurality of rays from a single origination point.

10. The method of claim 1, wherein said step of performing ray casting includes casting a plurality of rays from a plurality of origination points.

11. The method of claim 1, wherein said step of performing ray casting includes casting at least one ray within a plane of a predefined virtual space, said plane corresponding to a layer to be fabricated by said free-form fabrication machine of said article.

12. The method of claim 1, further comprising inputting the thickness of at least one layer to be fabricated by said free-form fabrication machine of said article into a program for controlling the operation of said free-form fabrication machine.

13. The method of claim 12, wherein the step of inputting layer thickness includes inputting different thicknesses for two adjacent layers.

14. The method of claim 1, further comprising controlling the resolution of the fabrication detail of said article in a predetermined direction by controlling the ray casting density during the step of performing ray casting.

15. The method of claim 1, further comprising using the results of said step of performing ray casting to create instructions for said solid free-form fabrication machine to fabricate at least a portion of said article.

16. The method of claim 15, further comprising storing said printing instructions in a computer-readable memory.

17. The method of claim 16, further comprising selecting said computer-readable memory from group consisting of volatile memory and permanent memory.

18. The method of claim 15, further comprising using said printing instructions on a second solid free-form fabrication machine to fabricate said article.

19. The method of claim 15, wherein the step of creating instructions includes using an error diffusion technique for ameliorating the effects of a portion of the printing mechanism of said solid free-form fabrication machine failing to print.

20. The method of claim 15, further comprising using said instructions to fabricate at least a portion of said article.

21. The method of claim 1, further comprising fabricating at least a portion of said article on said free form fabrication machine.

22. The method of claim 21, wherein said step of performing ray casting is conducted substantially contemporaneously with said step of fabricating.

23. The method of claim 22, further comprising controlling the resolution of the fabrication detail of said article in a predetermined direction by controlling the ray casting density during the step of performing ray casting.

24. The method of claim 21, further comprising inputting information about the thickness of a layer to be fabricated by said free-form fabrication machine of said article into a program for controlling the fabrication of said free-form fabrication machine after another layer of said article has been fabricated.

25. The method of claim 1, further comprising selecting said solid free-form fabrication machine to be a three-dimensional printing process machine.

26. The method of claim 1, further comprising selecting said free-form fabrication machine to be a selective laser sintering process machine.

27. A solid free-form fabrication system comprising:
(a) a solid free-form fabrication machine; and
(b) a computer readable program code for producing an article layer-by-layer by a free-form fabrication machine from an electronic file representation of the article, said program code including instructions for performing ray casting into said electronic file representation to determine at least one location to be printed by said free-form fabrication machine for fabricating said article.

28. The system of claim 27, wherein said solid free-form fabrication machine is a three-dimensional printing process machine.

29. The system of claim 27, wherein said solid free-form fabrication machine is a selective layer sintering process machine.

30. A computer readable program code for producing an article layer-by-layer by a free-form fabrication machine from an electronic file representation of the article, said program code comprising instructions for performing ray casting into said electronic file representation to determine at least one location to be printed by said free-form fabrication machine for fabricating said article.

31. A computer readable medium comprising a program code for producing an article layer-by-layer by a free-form fabrication machine from an electronic file representation of the article, said program code including instructions for performing ray casting into said electronic file representation to determine at least one location to be printed by said free-form fabrication machine for fabricating said article.

32. The computer readable medium of claim 31, wherein said computer readable medium is selected from the group consisting of magnetic recording media, optical recording media, and electronic recording media.
